(19) United States
(12) Patent Application Publication
(10) Pub. No.: US 2010/0318822 A1
(43) Pub. Date: Dec. 16, 2010

(54) ENERGY SAVING IN SYSTEMS-ON-CHIP

(75) Inventors: Alberto Scandurra, Messina (IT); Alan LLoyd, Bristol (GB); Raffaele Guarrasi, Grenoble (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: STMicroelectronics S.r.I., Agrate Brianza (MI) (IT); STMicroelectronics (Research & Development) Limited, Marlow-Buckinghamshire (GB)

(21) Appl. No.: 12/815,004

(22) Filed: Jun. 14, 2010

(30) Foreign Application Priority Data
Jun. 15, 2009 (IT) TO2009A000454

(51) Int. Cl. G06F 1/32; G06F 1/12

(52) U.S. Cl. 713/322; 713/323; 713/400

(57) ABSTRACT

A System-on-Chip may include initiators, targets exchanging information with the initiators, and a control module. The control module may be configured to selectively set to one of different reduced power consumption modes each of the initiators and each of the targets based upon external reduced power consumption instructions, and selectively wake-up from the reduced power consumption mode each initiator and each target.

### FIELD OF THE INVENTION

The present disclosure relates to techniques of reduction of the energy consumption of electronic circuits and has been developed with particular attention paid to its possible use in systems-on-chip (SoCs).

### BACKGROUND OF THE INVENTION

The design of electronic circuits at a nano-metric level has as key requisite of low energy consumption or, in general, energy efficiency. For example, the total energy consumed by a chip can be viewed as given by a sum of dynamic energy and static energy. The dynamic energy is the energy consumed in switching between logic states. The static energy (also known as dispersed energy) is consumed continuously even when the transistors are not switching. Unlike dynamic energy, dispersed energy is considered energy that is wasted since it does not contribute directly to operation of the SoC. Designing at the nano-metric level (in the region of 90 nm), or below this limit, increases exponentially the dispersion of energy by the transistors until it reaches levels higher than 50% of the total energy consumed by the chip. In order to reduce the contribution of dispersed energy, the logic modules can be turned off when they are not operating.

The “power control” technique is emerging as the best technique for tackling this complex problem. There exists different techniques for reducing the consumption of energy through power control. These techniques operate at different levels: architectural level; digital-design level; physical-design level; and technological level. At the architectural level it is possible to control energy consumption by way of a true dedicated module, usually referred to as a “low-power controller,” responsible for turning off the modules that make up the SoC that in a specific context are inactive. Turning off a block can mean either simply stopping the clock (clock gating) or interrupting the electrical supply (power switch-off).

At the digital-design level, it is possible to apply the technique of clock gating to the sequential logic in such a way that the clock is propagated to the various flip-flops only during switching operations so as to reduce the expenditure of dynamic energy to a minimum. Another technique at a digital-design level is that of providing dedicated encoders and decoders for encoding/decoding the data that may minimize the switching activity on the transmission channels, also in this case reducing the consumption of dynamic energy. However, in this case, it may be important to guarantee that the additional encoder and decoder do not occupy too much space on the chip, do not degrade the performance of the system as a whole, and do not consume much energy.

At the physical-design level, the techniques of power gating or power switch-off are provided usually with insertion of on-chip switches for selectively deactivating the supply of the current on the basis of the needs of the various applications. There are commonly two types of power-gating techniques: fine-grain power gating and coarse-grain power gating. In the first type, the switching transistors are encapsulated as part of the standard logic of the cell. In the second type, the power-gating transistors form instead part of the energy-distribution network and not of the standard cells. Finally, at the technological level, it is possible to use a number of supply voltages, using, where the requisite of speed is not of fundamental importance, low-absorption (low−V_{DD}) cells in order to reduce both the static energy and the dynamic energy.

### SUMMARY OF THE INVENTION

There is a desire to have available a system that exploits an alternative approach in terms of reduction of energy consumption.

The object of the disclosure is to provide a system that is able to solve the problems related to the reduction of energy consumption in SoCs. An approach is a System-on-Chip that may include a plurality of initiators, a plurality of targets exchanging information with the plurality of initiators, and at least one control module. The at least one control module may be configured to selectively set to one of a plurality of different reduced power consumption modes each of the plurality of initiators and each of the plurality of targets based upon external reduced power consumption instructions, and selectively wake-up from the reduced power consumption mode each initiator and each target.

### BRIEF DESCRIPTION OF THE DRAWINGS

The present embodiments may now be described, purely by way of non-limiting example, with reference to accompanying drawings, wherein:

FIG. 1 shows an exemplary embodiment of a multi-cluster SoC, according to the present invention;

FIG. 2 shows an exemplary embodiment of the VSTNoC cluster of FIG. 1;

FIG. 3 shows an exemplary embodiment of the control modules of FIG. 1;

FIG. 4 and FIG. 5 show, respectively, the signals exchanged between the modules in the VSTNoC case and in the STBus case, according to the present invention; and

FIG. 6 shows an exemplary embodiment of a system that comprises a module programmable within the target, according to the present invention.

### DETAILED DESCRIPTION OF THE PREFERRED EMBODIMENTS

Illustrated in the ensuing description are various specific details aimed at providing an in-depth understanding of the embodiments. The embodiments can be provided without one or more of the specific details, or with other methods, components, materials, etc. In other cases, structures, materials or operations that are known are not illustrated or described in detail in order not to obscure the various aspects of the embodiments.

Reference to “an or one embodiment” in the framework of this description is intended to indicate that a particular configuration, structure, or characteristic described in relation to the embodiment is comprised in at least one embodiment. Hence, phrases such as “in one embodiment” that may be present in different points of this description do not necessarily refer to one and the same embodiment. Furthermore, particular conformations, structures, or characteristics can be combined in any adequate way in one or more embodiments. The references used herein are only for convenience and hence do not define the sphere of protection or the scope of the embodiments.

In the sector of the semiconductors, standard approaches are used for the design of structures that are able to reduce energy consumption (both static and dynamic) and that may enable the inactive modules to be turned off during operation of the system.

The first type of approach, i.e. the one that aims at reducing energy consumption is fundamental, but is limited by certain technological factors. With reference to the current level of technology, the state of the art in regard to this first approach can be considered as by now achieved and consolidated.

In this way, the second type of approach, i.e. the one directed to switching-off the inactive modules, becomes strategic for enabling possible further reductions of energy consumption. However, this second approach introduces certain critical points on the control of the global performance of the system and on the integrity of the data exchanged between the different Intellectual Property (IP) nodes.

If executed completely, the energy-saving procedure (indicated in what follows also with the term “power-down”) ensures completion of the transfer of information for the pending operations; moreover, in high-efficiency systems, the procedure of switching back on is characterized by a high speed to have a low impact on the performance of the system.

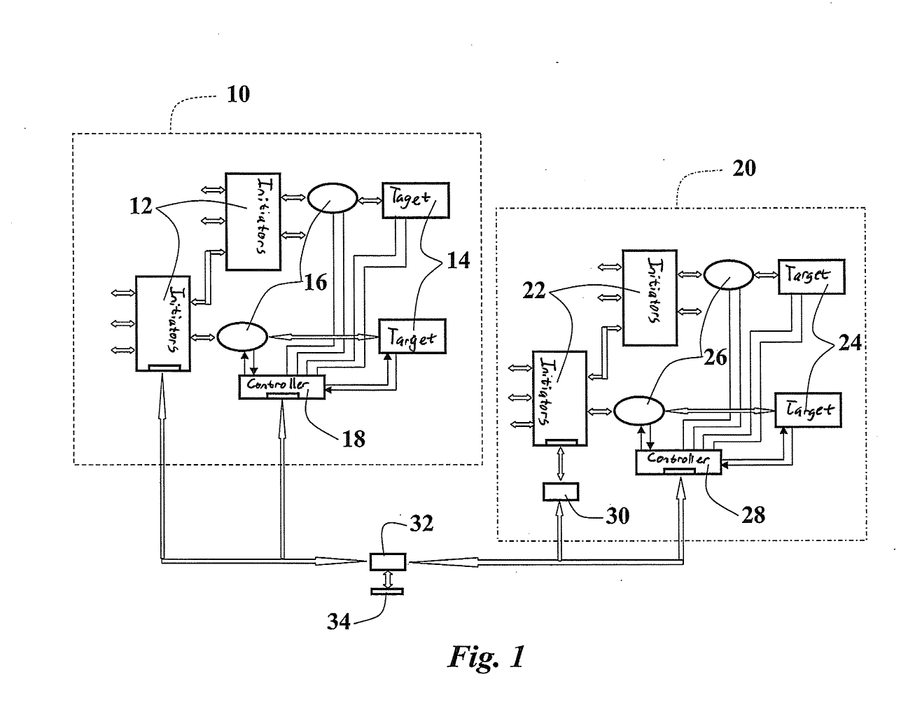

FIG. 1 shows the use of two Power Management Unit (PMU) control modules in a multi-cluster interconnected system in which a cluster 10 of a STBus type and a cluster 20 of Versatile ST Network on Chip (VSTNoC) type are present. The cluster 10 of a STBus type comprises two STBus nodes, designated by the reference 12, that act as initiators, and two nodes 14 that act as targets. There are moreover present two tracker nodes 16 that connect the initiators 12 and the targets 14 to one another and that function as interfaces. The PMU control module, designated by the reference 18, is connected to a node 32 that is a decoder register of type 1, which in turn communicates with a STBus port 34 of type 1.

In a similar way, the VSTNoC cluster 20 comprises two VSTNoC initiator nodes 22 and two target nodes 24. There are moreover present two interface nodes 26 (NI targets) that connect the initiators 22 and the targets 24 and a PMU control module 28 to one another. The embodiment considered herein is based upon the PMU control modules (Power Controller Module or Power Management Unit) 18, 28, each of which acts as centralized energy controller and enables individual and separate setting in a condition of energy saving of each of the initiators 12, 22 and targets 14, 24.

It may be appreciated on the other hand that, in simpler embodiments, there may be present even just one of the modules 18, 28. The detailed characteristics described herein in relation to both of the modules 18, 28 can hence be present in just one of these modules, even in the case where both of the modules are envisioned. In one embodiment, the PMU modules 18, 28 contain some registers that enable the software being executed on the central processing unit (CPU) to send instructions for setting some parts of the SoC into an energy-saving (power-down) condition.

The modules 18 and 28 are able to block (and subsequently start off again) propagation of the traffic and assume a state that indicates whether the traffic is stationary or otherwise. For this purpose, the PMU modules 18 and 28 collaborate, according to the handshaking procedure, with the initiators that have the capacity of setting themselves in conditions of energy saving (power-down), and with the NI interfaces of the target (in the case of VSTNoC) or with the trackers (in the case of STBus) that can be turned off.

The PMU control modules are moreover responsible for control of the gates for access to the supply or the clock, which effectively enable turning-off of the supply or the clock. The energy-saving (power-down) condition is characterized by a state of quiescence or inactivity of the modules involved that it is possible to obtain by disabling the clock or reducing to a minimum its operating frequency. Instead, in the condition of power switch-off, the supply to the modules is effectively removed, but this renders the wake-up procedure of the modules slower.

At any moment, an application can decide to turn off or send into energy-saving condition an initiator or a target to safeguard the energy balance of the system. For example, in the case of soft-reset, when there are no longer operations suspended, the initiator can be turned off autonomously. The target nodes are more complex to manage, because they do not control the traffic that reaches them.

Three power-down modes are envisioned: i) switching-off of the supply voltage (or current); ii) switching-off of the clock; and iii) reduction of the operating frequency of the clock. When the clock or the voltage is turned off, an IP node or an entire subsystem cease to respond to external stimuli for a significant lapse of time. It is useful to verify that other portions of the system are not waiting for operations or data from the deactivated modules.

When the clock frequency is simply reduced, the system is never completely blocked and there exists a mechanism for resuming the normal operating frequency when some activity is detected on the STBus interface. For the energy-saving (power-down) mode, two scenarios are envisioned: the one generated by the handshake procedure, and the one generated by the lack of traffic.

The second scenario regards only the targets and enables switching-off of just the clock and not of the supply, because this latter possibility implies that the system may have a rapid wake-up capacity in the case where a new operation to be performed arrives.

In the same way, two scenarios may be expected also for the wake-up mode: the one generated by the handshake procedure, and the one generated by arrival of traffic at input. Once again the second scenario regards only targets that have gone into the power-down condition following upon the lack of traffic. The energy-control protocol is based upon a simple interface through which the PMU module interacts with the final target and/or the interconnection or interface element (Tracker or NI Target).

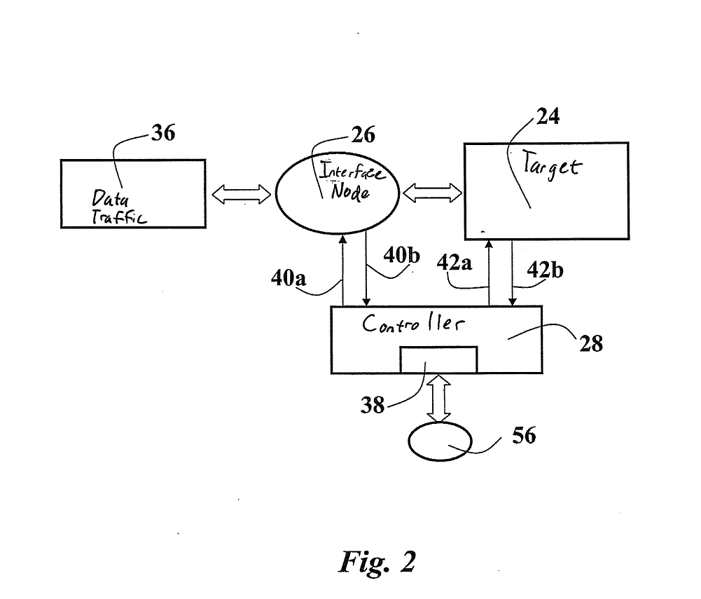

In the following figures parts, elements or components that are identical or equivalent to ones already described with reference to FIG. 1 are designated by the same reference numbers, thus rendering repetition of the corresponding description superfluous. In FIG. 2, the data traffic is designated by the reference 36. The target interface 26 receives from the PMU module 28 a signal 40a of stop_traffic and responds with a signal 40b of channel_closed. The PMU module 28 sends to the target 24 a gate signal 42a (control signal of the supply or of the clock) and receives from the target 24 a signal 42b of target_ready. In one embodiment, the PMU module 28 comprises a programming module 38 that interacts with an STBus programming port 56 of type 1.

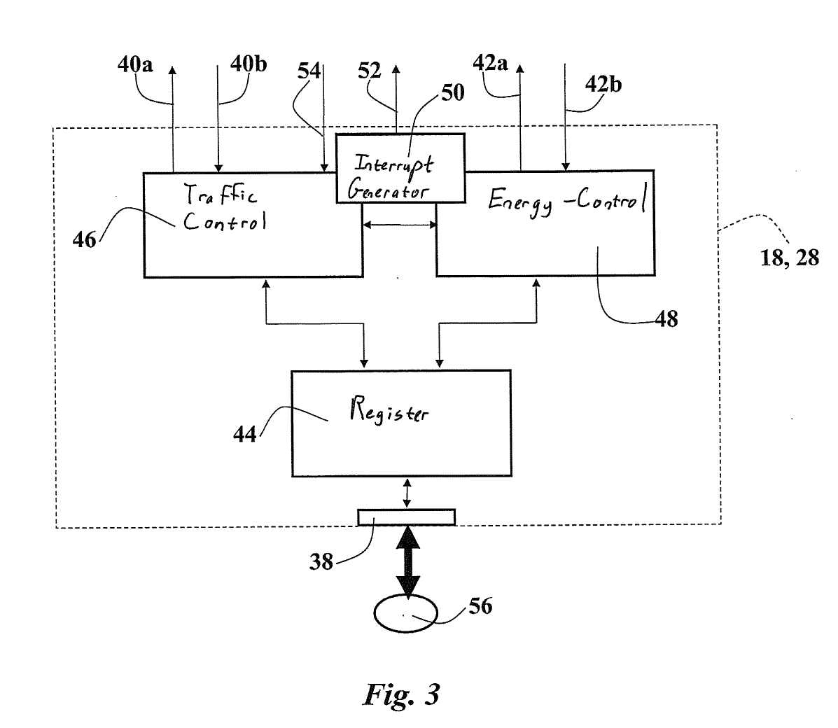

In the micro-architecture of the PMU module four main functional blocks (FIG. 3) can be identified: a register block 44, responsible for programming the internal registers of the PMU module; a traffic-control block 46, responsible for the suspension of the traffic directed to the selected target (signal stop_traffic 40a) during the switch-off procedure and resumption of the traffic during the wake-up procedure; the block 46 is moreover responsible for identification of external interrupts 54 such as the ones generated by a tracker when a request reaches it at an instant in which the corresponding target is in an energy-saving (power-down) condition; a energy-control block 48, responsible for arrest of the clock or of the electrical supply of the target selected during the switch-off procedure, and for restart of the clock or of the electrical supply during the wake-up procedure; and an interrupt generator 50, responsible for generation of interrupts 52 and for control of the interrupts.

Once again with reference to FIG. 3, the register block 44 is connected to a STBus port 56 of type 1. In one embodiment, the PMU module is equipped with the following interfaces: a system interface for supplying clock and reset signals to the PMU module; an STBus interface of type 1 used for access to the internal registers, responsible for setting and monitoring the state of the modules to be controlled; and a series of dedicated interfaces that implement the low-energy-consumption protocol, responsible for effective implementation of the procedures of switch-off/wake-up of the targets.

The following tables describe a part of the signals that circulate in the system. In particular Table 1 comprises the signals of the system interface, Table 2 comprises the signals of the programming interface, and Table 3 comprises the signals of the power-down interface.

TABLE 1

| Signal name | I/O | Timing | Description |
|---|---|---|---|
| Clk | I | N/A | PMU clock |
| rst_n | I | N/A | PMU reset - active low |

TABLE 2

| Signal name | I/O | Timing | Description |
|---|---|---|---|
| prog_req | I | Late | Request |
| prog_opc | I | Late | Identifier of type of |
| | | | operation |
| prog_add<8:2> | I | Late | Address |
| prog_data<31:0> | I | Late | Data writing |
| prog_r_req | O | Early | Request for reply |
| prog_r_opc | O | Early | Operation state |
| prog_r_data<31:0> | O | Early | Data reading |

TABLE 3

| Signal name | I/O | Timing | Description |
|---|---|---|---|
| Stop_traffic<N - | O | Early | Request for arrest of the |
| 1:0> | | | traffic |
| channel_closed<N - | I | Late | Acknowledgement of traffic |
| 1:0> | | | stopped |
| Gate<N - 1:0> | O | Early | Energy control or clock |
| target_ready<N - | I | Late | State of target energy |
| 1:0> | | | mode |
| wake_up_req<N - | I | Late | External wake-up request |
| 1:0> | | | |
| interrupt | O | Early | Interrupt to the host in |
| | | | the case of a single line |
| interrupt_1 | O | Early | Interrupt #1 to the host |
| | | | in the case of multiple |
| | | | lines |
| interrupt_2 | O | Early | Interrupt #2 to the host |
| | | | in the case of multiple |
| | | | lines |

The PMU module is configured for functioning at the low frequency of the peripheral subsystem of type 1, namely at most 200/250 MHz; ideally its clock is the same as that of the STBus-decoder register of type 1 that accesses its programming port. The input signals channel_closed 40b and target_ready 42b are controlled, respectively, at the VSTNoC frequency and at the target frequency, but since the frequencies are stable for a long period of time, potentially, the synchronization is not necessary within the PMU module. In this way, the overall operation of the PMU module can be viewed as completely synchronous, while the communications with the target interface and the STBus tracker can be viewed as an asynchronous handshake. However, in alternative embodiments it is possible to envision the presence of synchronizers.

The PMU module is able to control the energy state of a number N of targets. The target interface and the STBus tracker bring the signal channel_closed 40b to the low level “0” after having received the reset command. The signal channel_closed 40b is brought to the high level “1” only when the signal stop_traffic 40a is in its active state and the traffic has been interrupted. Furthermore, the signal channel_closed 40b is again brought back to its deactivated state when the signal stop_traffic 40a returns to the low level.

The STBus tracker brings the signal ext_int 54 to the low level “0” after having received the reset command. The signal ext_int 54 is brought to the high level “1” only when the corresponding target is in an energy-saving (power-down) condition and a request reaches the tracker. In these conditions, the tracker is programmed in such a way as to generate an interrupt towards the PMU module and not generate an error message towards the initiator. The interrupt serves to indicate to the PMU module that the target selected may be woken up in so far as there has arrived a request for access to the target (for example, for operations of reading or writing).

In addition to the number of targets to be controlled with the PMU module and to the number of external interrupt lines present, other parameters enable specification of the presence of synchronizers for the source of the interrupts at input, in the case where they come from sectors with different clocks. The complete set of the parameters of the PMU module is given in Table 4.

TABLE 4

| | | Validity | Reference |
|---|---|---|---|
| Parameter | Description | range | value |
| tgt_nb | Number of targets | 1 to 64 | 4 |
| | controlled by the PMU | | |
| int_nb | Number of external | 1 to 2 | 1 |
| | interrupt lines | | |
| trf_ctrl_synch | Specifies whether to | True/False | False |
| | install synchronizers | | |
| | between TNI/tracker | | |
| | and PMU | | |
| trf_ctrk_synch_len | Number of FF | 0 to 16 | 0 |
| | synchronizations | | |
| | between TNI/tracker | | |
| | and PMU | | |
| tgt_ctrl_synch | Specifies whether to | True/False | False |
| | install synchronizers | | |
| | between target and PMU | | |
| tgt_ctrk_synch_len | Number of FF | 0 to 16 | 0 |
| | synchronizations | | |
| | between target and PMU | | |

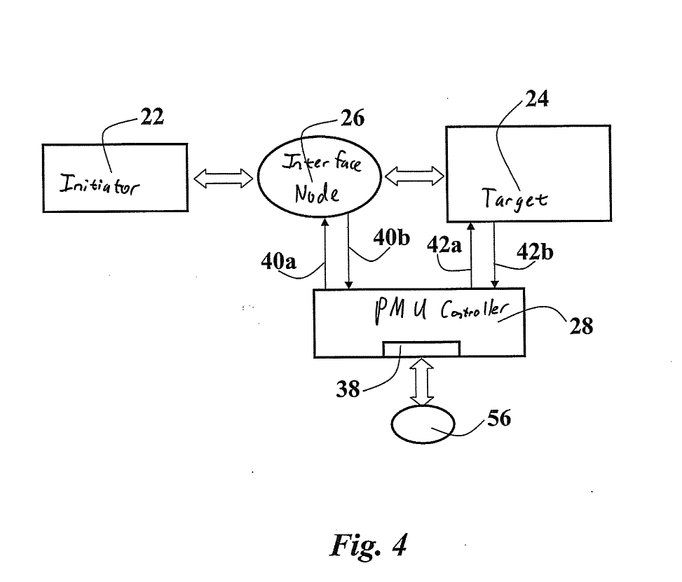

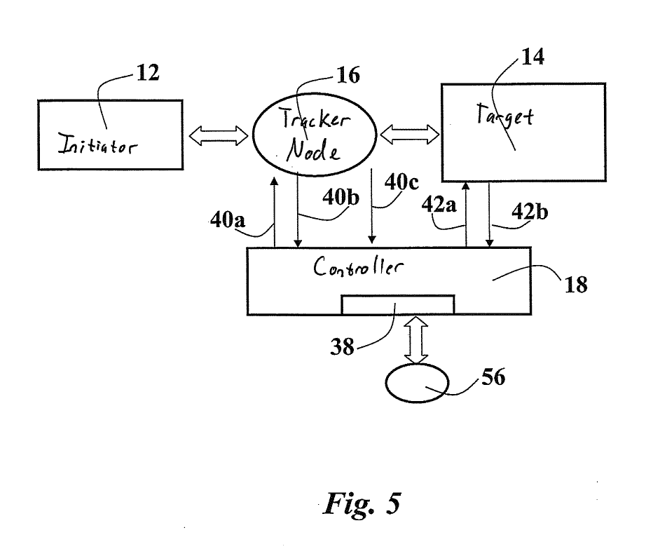

FIGS. 4 and 5 show the connections between the PMU module 18, 28 and the interconnection modules, namely the interface 26 of the target in the case of VSTNoC and the tracker 16 in the case of STBus, together with the corresponding targets 24 and 14, respectively. With reference to FIG. 5, in this case, the tracker 16 sends to the PMU module 18 also a signal of wake_up_req designated by the reference 40c. In what follows, the different procedures to bring a target into an energy-saving (power-down) condition or a condition of wake-up from the condition are described.

The effective switching-off of a target can be performed either by the CPU, informed by the PMU module on the state of the traffic through an interrupt signal, or via polling, or by the same PMU module via a direct internal connection. In the same way, also the wake-up of a target can be performed either by the CPU, informed by the PMU module on the state of the target through an interrupt signal, or via polling, or by the same PMU module via a direct internal connection. The choice is made by appropriately programming the registers of the PMU module.

Procedure for switching off a single target are as follows. 1) The host accesses the PMU module and sets the register stop_traffic corresponding to the target to be turned off at the high value “1.” 2) The PMU module generates the signal stop_traffic 40a. 3) The interface or the tracker of the selected target sees to blocking in safety (i.e., without loss of data) any pending operation, and then brings the signal channel_closed 40b to the high value “1.” 4) The PMU module records the state of channel_closed and in the interrupt mode sends an interrupt to the host or else, in the polling mode, the host itself self-detects the state of the internal registers through querying. 5) The host accesses the PMU module and sets the gate register corresponding to the target to be turned off to the high value “1.” 6) The PMU module brings the gate signal 42a of the target selected to the high value “1.” 7) When the target is turned off, the signal target_ready 42b received by the PMU module is brought into the deactivated state.

Procedure for waking up a single target is as follows. 1) The host accesses the PMU module and sets the gate register corresponding to the target to be woken up to the low value “0.” 2) The PMU module brings the gate signal 42a of the target selected to the low level “0.” 3) Once the time necessary for recovering the clock or the electrical supply in the domain of the target has elapsed, the target itself renders the signal targ_ready 42b active. 4) The PMU module records the state of targ_ready and in the interrupt mode sends an interrupt to the host or else, in the polling mode, the host itself self-detects through querying the state of the internal registers. 5) The host accesses the PMU module and sets the register of stop_traffic corresponding to the target selected to the low value “0.” 6) The PMU module brings the signal stop_traffic 40a into the deactivated state. 7) The NI interface or the tracker of the target selected sees to bringing the signal channel_closed 40b into the deactivated state. The PMU module is configured for managing in a more efficient way the basic procedures described herein, rendering configurable, through programming, the following functions.

### Automatic Procedures of Switch-Off and Wake-Up

Through programming, the PMU module can execute automatically the steps of the previous procedures rendering step 5 redundant. The host system is entrusted only with setting underway the procedures that may then be completed without the need for other operations.

### Management of the Multi-targets and Global-Interrupt Mode

By programming the Global-Interrupt mode and with the aim of executing the procedures of switch-off and wake-up on a series of targets, the PMU module may send just one interrupt when all the TNI/Trackers (targets) of the set selected are in adequate conditions (see step 4 of the previous procedures). Through this function, the host system can easily manage energy control of partitioned groups of IP cores.

### Generation of the Error Mode and Propagate (Tracker) Mode

When properly configured through setting of an interface signal, the Tracker is able to stop the traffic that is entering a target turned off or else to inform, through the PMU module, the host system that a new STBus operation has been received. In the error mode, the tracker arrests propagation of the STBus requests available at its interface after having brought the signal channel_closed 40b into the activated state. It generates the corresponding responses, characterized by the indication of power-down error, and sends them to the initiator instead of to the target turned off.

In the propagate mode, when the signal channel_closed 40b is in the activated state, the tracker awaits the first request regarding a new STBus operation for bringing the signal wake_up_req 40c into the activated state, pointing out to the PMU module (through the port ext_int) that the target may again be turned on. Once this target is again active, the PMU module brings the signal stop_traffic 40a into the deactivated state, and then the tracker resumes the requests for transfer thereto.

### Sequence of the Procedure Wake Up

1) The tracker renders the signal wake_up_req 40c active.
2) The PMU module generates an interrupt 52 for the host.
3) The host wakes up the target directly, without involving the PMU module or through it.
4) Once the time necessary for recovering the clock or the electrical supply in the domain of the target has elapsed, the target itself renders the signal targ_ready 42b active.
5) The PMU module generates a new interrupt 52 for the host.
6) The host accesses the PMU module, resets (sets to the low level “0”) the bit of the register of the source of the interrupt and sets the bit of the register stop_traffic corresponding to the target selected to the low level “0.”
7) The PMU module brings the signal stop_traffic 40a into the deactivated state and sends it to the NI interface or to the tracker of the target selected and waits for the latter to bring the signal channel_closed 40b into the deactivated state.
8) The NI interface or the tracker brings the signal channel_closed 40b into the deactivated state.

### Wake-Up Procedure Based Upon SRC (TNI)

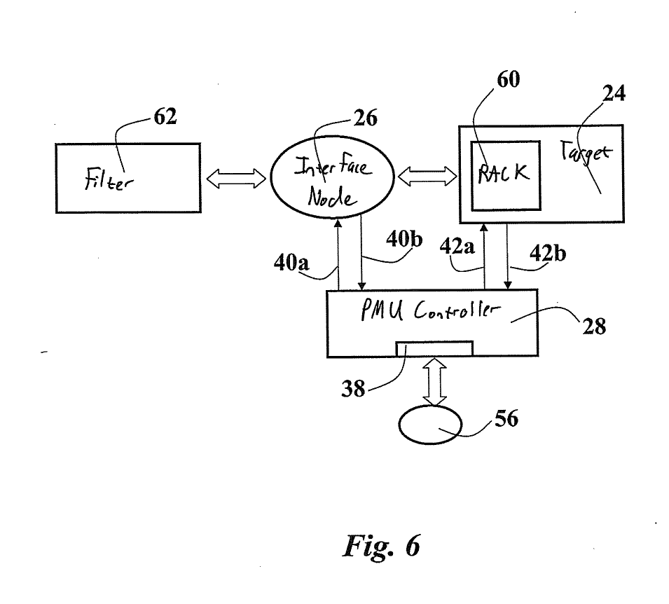

The TNI interface of the target can introduce an optimization into the wake-up procedure in the case of the clock-gating approach when the target is not turned off, but the energy consumption is reduced only through switching-off of the clock or reduction of its frequency by way of a purposely provided programmable block referred to as Request ACtivated clock (RACK) designated by the reference 60 in FIG. 6.

The RACK block 60 is a cell of a gate type with the clock controlled by a request signal, which means that as long as the incoming request signal is low (in accordance with both the STBus protocol and the STNoC protocol), the clock of the target is turned off or slowed down according to the programming of the RACK block 60; when the request signal is high, the RACK block 60 wakes up the target causing the clock to start off again for the time necessary for completing the new operation that has been set underway. Next, the clock is again controlled on the basis of the values of the registers of the RACK block 60.

With reference to FIG. 6, a block 62 enables filtering of the requests that reach the RACK block 60 on the basis of the value of the incoming SRC; the packets distinguished by an authorized SRC are propagated to the target, which is temporarily woken up, without any effect on the state of the PMU module, while the packets distinguished by non-authorized SRCs are stopped by the TNI interface or by the tracker.

The method affords the possibility of controlling the consumption of energy in SoCs in a dynamic way and with various advantages. The energy-control module is programmable via SW by the host system. The energy-saving (power-down) procedure is independent of the IP protocol. The temporary-wake-up procedure is compatible with STBus/AXI, which can be readily extended to other protocols. Total safety of the completion of each pending transaction towards the target selected is guaranteed. The energy-saving (power-down) condition is achieved by stopping the clock, or simply slowing it down. The host system is informed via interrupt signals. It is possible to wake up a target temporarily in the case of critical operations. The targets can be treated either individually or in groups, thus reducing the number of signals sent in this latter case. It can be used even in the case of power shut-off. By analyzing the memory map of the system, in particular as regards the registers mapped in the memory, it is possible to detect whether a programmable module is used that follows the philosophy of the PMU module. From a functional standpoint, the behavior of the PMU module can be inferred from an analysis of the firmware code.

Without prejudice to the principle of the present embodiments, the details of construction and the embodiments may hence vary, even significantly, with respect to what has been illustrated herein purely by way of example, without thereby departing from the scope of the present embodiments, as defined by the annexed claims.

1-12. (canceled)

13. A System-on-Chip (SoC) comprising:
a plurality of initiators;
a plurality of targets exchanging information with said plurality of initiators; and
at least one control module configured to
individually and separately select and set to one of a plurality of different reduced power consumption modes each of said plurality of initiators and each of said plurality of targets based upon reduced power consumption instructions from outside the System on-Chip, and
individually and separately select and wake-up from the different reduced power consumption mode each initiator and each target.

14. The SoC of claim 13 wherein said at least one control module is configured to block traffic to the selected targets while in the selected reduced power consumption mode.

15. The SoC of claim 13 wherein said at least one control module is configured to control a power supply and a clock signal for each said initiator and each target.

16. The SoC of claim 13 wherein the plurality of different reduced power consumption modes comprises a power switch-off mode, a clock switch-off mode, and a reduced clock operating frequency mode.

17. The SoC of claim 13 wherein said at least one control module includes:
a plurality of internal registers and a register block configured to program said plurality of internal registers;
a traffic control block configured to stop and resume traffic toward the selected target and detect external interrupts;
a power control block configured to stop and restart at least one of a clock and a power supply to the selected target; and
an interrupt generator configured to generate interrupts.

18. The SoC of claim 17 wherein said at least one control module includes a synchronization module configured to synchronize interrupts from different clock domains.

19. The SoC of claim 17 further comprising:
a system interface configured to deliver reset and clock signals towards said at least one control module;
a STBus type 1 interface configured to access said plurality of internal registers of said at least one control module, and to set and monitor a status of initiator and target modules to be controlled; and
a set of dedicated interfaces configured to implement a reduced power protocol.

20. The SoC of claim 13 wherein said at least one control module includes a programmable module configured to program selection of the plurality of different reduced power consumption modes based upon the reduced power consumption instructions.

21. The SoC of claim 13 wherein said plurality of targets includes a programmable module configured to filter incoming requests based upon information associated with the initiator that has generated the requests.

22. The SoC of claim 13 wherein said at least one control module is configured to temporarily wake-up a target for critical operation.

23. The SoC of claim 13 wherein said at least one control module is configured to ensure completion of pending transactions for the selected target.

24. The SoC of claim 13 wherein said at least one control module is configured to control said plurality of initiators and said plurality of targets arranged in groups thereof.

25. A System-on-Chip comprising:
a plurality of initiators;
a plurality of targets exchanging information with said plurality of initiators; and
at least one control module configured to
selectively set to one of a plurality of different reduced power consumption modes each of said plurality of initiators and each of said plurality of targets based upon external instructions, and
selectively wake-up from the different reduced power consumption mode each initiator and each target.

26. The SoC of claim 25 wherein said at least one control module is configured to block traffic to respective targets while in the reduced power consumption mode.

27. The SoC of claim 25 wherein said at least one control module is configured to control a power supply and a clock signal for each said initiator and each target.

28. The SoC of claim 25 wherein the plurality of different reduced power consumption modes comprises a power switch-off mode, a clock switch-off mode, and a reduced clock operating frequency mode.

29. The SoC of claim 25 wherein said at least one control module includes:
a plurality of internal registers and a register block configured to program said plurality of internal registers;
a traffic control block configured to stop and resume traffic toward the respective target and detect external interrupts;
a power control block configured to stop and restart at least one of a clock and a power supply to the respective target; and
an interrupt generator configured to generate interrupts.

30. A method of operating a System-on-Chip comprising a plurality of initiators, and a plurality of targets exchanging information with the plurality of initiators, the method comprising:
selectively setting to one of a plurality of different reduced power consumption modes each of the plurality of initiators and each of the plurality of targets based upon external instructions; and
selectively waking-up from the different reduced power consumption mode each initiator and each target.

31. The method of claim 30 further comprising blocking traffic to respective targets while in the reduced power consumption mode.

32. The method of claim 30 further comprising controlling a power supply and a clock signal for each of the initiator and each target.

33. The method of claim 30 wherein the plurality of different reduced power consumption modes comprises a power switch-off mode, a clock switch-off mode, and a reduced clock operating frequency mode.
